(19) United States
(12) Patent Application Publication
(10) Pub. No.: US 2025/0314533 A1
(43) Pub. Date: Oct. 9, 2025

(54) OPTICAL SENSOR ELEMENT, THERMAL IMAGE SENSOR AND METHOD OF DETECTING THERMAL RADIATION

(71) Applicant: ams Sensors USA Inc., PLANO, TX (US)

(72) Inventor: Ananth TAMMA, BOISE, ID (US)

(73) Assignee: ams Sensors USA Inc., PLANO, TX (US)

(21) Appl. No.: 18/865,921

(22) PCT Filed: May 16, 2023
(86) PCT No.: PCT/US2023/022319

§ 371 Date: Nov. 14, 2024

Related U.S. Application Data
(60) Provisional application No. 63/342,769, filed on May 17, 2022.

(51) Int. Cl. G01J 5/10; G01J 5/00; G01J 5/0806

(52) U.S. Cl. CPC G01J 5/10; G01J 5/0806; G01J 2005/0077; G01J 2005/106

(57) ABSTRACT

An optical sensor element for sensing thermal radiation comprises a light emitter having a cavity, the light emitter being configured to emit coherent electromagnetic radiation through an emission surface and to undergo self-mixing interference, SMI, caused by reflected electromagnetic radiation reinjected into the cavity. A micro-opto-mechanical transducer is arranged distant from the emission surface, the transducer being configured to undergo mechanical deflection according to thermal radiation absorbed by the transducer, and to reflect the electromagnetic radiation emitted by the light emitter back into the cavity for generating the SMI. A detection unit is configured to detect a degree of the generated SMI, determine from the detected degree a deflection of the transducer, and generate an output signal indicating the determined

### CROSS-REFERENCE TO RELATED APPLICATIONS

The present application is a national stage entry from International Application No. PCT/US2023/022319, filed on May 16, 2023, published as International Publication No. WO 2023/224943 A1 on Nov. 23, 2023, and claims the benefit of U.S. Provisional Application No. 63/342,769, filed on May 17, 2022, all of which are incorporated by reference herein in their entireties.

### FIELD OF THE INVENTION

This disclosure relates to an optical sensor element for detecting thermal radiation, a thermal image sensor comprising a plurality of such optical sensor elements, and to a method of detecting thermal radiation.

### BACKGROUND OF THE INVENTION

Thermal imaging, often also referred to as infrared thermography, is a technique for generating optical images based on photons in the long-wavelength infrared, LWIR, regime, typically between 9 and 14 μm. This is due to the black body radiation law, according to which all objects with a temperature above absolute zero emit infrared radiation, wherein the amount of radiation emitted by an object increases with temperature. Thus, thermal imaging enables to visualize an environment with or without visible illumination. Applications of thermal imaging include thermal mapping, medical imaging, building diagnostics and night vision, for instance. Therein, thermal imaging cameras convert the energy in the infrared wavelength into a visible light display.

Conventional thermal imaging cameras are bulky and expensive. In order to enable thermal imaging solutions also to portable electronic devices, e.g. smartphones, wearables and laptops, integrated solutions are necessary, as space constraints besides price often poses the biggest challenge in these devices. The ubiquitous silicon-based CMOS image sensors often employed in mobile devices (CIS) can only image in the visible (400-700 nm) and part of the near-infrared (700-1000 nm) spectral range. Hence, silicon cannot be used as an absorbing material in the thermal or LWIR spectral range. Therefore, conventional approaches of thermal cameras for these applications, e.g. micro-bolometer arrays, use highly sensitive micro-opto-mechanical, MOM, transducers such as bi-metallic cantilevers in order to detect thermal radiation. The deflection of these cantilevers is commonly read out piezo-electrically, resistively or capacitively. These readout schemes, however, experience issues such as lack of thermal isolation and Johnson noise.

State-of-the-art optical techniques are capable of detecting a thermal expansion of bi-metallic cantilevers with sub-angstrom resolution only limited to thermal vibrational noise. However, existing optical readout approaches utilize a deflection measurement using light from an LED with diffractive optical elements or from a laser, a technique also known from atomic force microscopy, wherein light is reflected off the cantilever and directed towards a CIS. The thermal image is then calculated by measuring a deflection of the spot using a multi-channel photodetector as temperature changes. This indirect measurement, however, can lead to issues with accuracy and adds a software burden for tracking and computing the position of the light spot. In addition, such camera systems are not compact and are sensitive to external mechanical vibrations and alignment issues.

Thus, an object to be achieved is to provide an optical sensor element for detecting thermal radiation with high sensitivity and compact structure. A further object is to provide a thermal image sensor comprising a plurality of such optical sensor elements, and a method of detecting thermal radiation.

These objects are achieved with the subject-matter of the independent claims. Further developments and embodiments are described in dependent claims.

### SUMMARY OF THE INVENTION

This disclosure overcomes the abovementioned technical limitations by providing a simple, compact optical sensor element for thermal imaging that is based on optical interferometry, wherein thermal radiation is converted into an optical interferometric signal that is directly read out by means of a detection unit. Therein, an optical sensor element according to the improved concept utilizes a highly sensitive micro-opto-mechanical transducer in order to detect thermal radiation. The deflection of the transducer due to absorbed thermal radiation is detected optically using interferometric detection that is based on self-mixing interferometry, SMI, in a cavity of the readout light emitter. Therein, a degree of the SMI signal is proportional to the thermal energy incident on and absorbed by the MOM transducer leading to a significantly enhanced accuracy in measurements compared to existing solutions. Moreover, due to the reduction in mechanical elements, the system is much less sensitive to vibrations and alignment. In particular, the present disclosure utilizes the light emitter for both emission and detection. Thus, the disclosure combines the well-known concept of temperature detection using bi-metallic cantilevers as transducers, for example, along with optical deflection from the transducer such that thermal images can be directly read-out using a commercial light emitter for optical readout of optical interferometric self-mixing.

In an embodiment, an optical sensor element for sensing thermal radiation comprises a light emitter having a cavity, wherein the light emitter is configured to emit coherent electromagnetic radiation through an emission surface. The light emitter is further configured to undergo self-mixing interference, SMI, which is caused by reflected electromagnetic radiation reinjected into the cavity. The optical sensor element further comprises a micro-opto-mechanical transducer that is arranged distant from the emission surface, wherein the transducer is configured to undergo a mechanical deflection according to thermal radiation incident on and absorbed by the transducer. The transducer is further configured to reflect the electromagnetic radiation emitted by the light source back towards the emission surface of the light emitter such that it reenters the cavity for generating the SMI. In other words, the reflected electromagnetic radiation is reinjected into the cavity. Moreover, a detection unit of the optical sensor element is configured to detect a degree of the generated SMI, determine from the detected degree a deflection of the transducer, and generate an output signal indicating the determined deflection.

The light emitter, e.g. a laser such as a vertical-cavity surface-emitting laser, VCSEL, has a laser cavity and emits electromagnetic radiation through a partially transmissive end mirror, e.g. Bragg mirrors, arranged on a top side of the laser cavity. Therein, the term “top side” refers to a side of the laser facing away from a substrate body the light emitter is arranged on. In particular, the light emitter can be arranged on a substrate, e.g. a CMOS silicon die, such that a bottom side of the light emitter is parallel to and faces the substrate. The substrate can comprise laser contacts for electrically connecting the laser to a laser driver. The substrate can further comprise an integrated circuit for controlling an emission of the light emitter and circuitry for reading out the SMI signal. For example, such integrated circuits comprises passive and active circuitry for determining a degree of the SMI, including a transimpedance amplifier, for instance.

The transducer is arranged on a side of the light emitter opposite the substrate, i.e. the transducer is arranged distant from the emission surface of the light emitter such that a deflection of the transducer due to an absorption of thermal radiation alters a gap in between the light emitter and the transducer. In other words, a deflection of the transducer alters an optical path length of an optical mode, wherein the path length is formed by the cavity and the gap. For example, the transducer is part of a MEMS die that is bonded to the substrate via spacers, for instance. The transducer is configured to experience a deflection upon absorption of thermal photons, i.e. photons in the LWIR range. This can be realized by means of a transducer that is formed in a manner such that it has regions of different coefficients of thermal expansion. Thus, for any given energy absorption, these different regions experience a different expansion, creating a stress or strain within the transducer such that the latter shows a deflection, e.g. as a consequence of a deformation, displacement or bending.

The transducer has a reflective surface, e.g. a bottom surface of the transducer, which faces the emission surface and can thus receive electromagnetic radiation that is emitted by the light emitter through the emission surface. Therein, at least a portion of the electromagnetic radiation received from the light emitter is reflected off the reflective surface and directed back towards the emission surface. At least a portion of this reflected electromagnetic radiation is coupled via the emission surface back into the cavity causing the self-mixing interference. Self-mixing interference in turn causes an alteration, e.g. modulation, of the optical power in the cavity and thus of the output power of the light emitter through the emission surface. In other words, the transducer converts thermal energy into mechanical deflection. Moreover, the occurrence of self-mixing interference converts the mechanical deflection into an optical interference signal.

The detection unit, e.g. realized by means of an integrated circuit, detects the interferometric signal by means of monitoring an electrical property of the light emitter or by monitoring an optical output power of the light emitter, for instance. The interferometric signal carries information about a degree of self-mixing interference, which in turn carries information about an exact deflection of the transducer in a direction of emission of the light emitter, i.e. along the optical path. Thus, the detection unit can generate an output signal indicative of a momentary position of the transducer in terms of its deflection, which is in turn indicative of an amount of thermal radiation absorbed by the transducer. Hence, the detection unit converts the optical interference signal into an electrical output signal that carries information about a degree of interference.

In an embodiment, the micro-opto-mechanical transducer comprises a bimorph or bimetallic-type layer structure formed from a first and a second material with different coefficients of thermal expansion. For example, the transducer is a bimorph or bimetallic strip comprising two strips of different materials that expand at different rates with changing temperature. As the absorption of thermal photons causes a heating of the transducer, the different expansions thus force the otherwise intrinsically flat strip to bend away from its resting position if heated in a first direction, and into a second direction opposite the first direction if cooled below its initial temperature.

Specifically, the material having the respectively higher coefficient of thermal expansion is on the outer side of the curvature of bending when the strip is heated and on the inner side when cooled. It is noted, that in this context the terms “bimorph” and “bimetallic-type” are used to emphasize the conversion of thermal radiation into mechanical deformation using a transducer formed from two different materials with different thermal expansion behavior. Particularly, the term bimetallic-type does not necessarily require that the first and second materials both are metals.

In an embodiment, the first material comprises silicon and the second material is a metal. For example, the first material is intrinsic silicon or silicon nitride, and the second material is a metal such as gold. Silicon is characterized by a linear coefficient at 20° C. of 2.56*10⁻⁶ K⁻¹, while that of gold is 14*10⁻⁶ K⁻¹ at the same temperature, thus a factor of roughly six larger. A similar significant difference between the two materials is observed for the volumetric coefficient, which is 9*10⁻⁶ K⁻¹ in case of silicon and 42*10⁻⁶ K⁻¹ in case of gold. Alternative metals having a significantly different thermal expansion coefficient from silicon include silver, copper, aluminum and brass. Thus, the transducer can be formed from silicon as the first material and a metal as the second material, such that significant deflection of the transducer is achieved upon absorption of thermal photons within the two materials.

In an embodiment, the first material forms a strip and the second material is arranged on a top and a bottom side of the strip. In order to realize a deflection along the optical path, the transducer can be formed by a first layer of silicon that is coated with the second material, e.g. gold, wherein the first layer is parallel to and faces the emission surface, while the second layer faces away from the emission surface. For example, the side of the transducer facing the light emitter is formed from silicon or silicon nitride while the side facing away from the light emitter is formed from a metal, or vice versa. The bimetallic-type layering for forming the transducer is also referred to as the transducer being a bimetal bimorph structure.

In an embodiment, the micro-opto-mechanical transducer is a cantilever. For example, the transducer is a rigid structural element that extends horizontally, i.e. parallel to the emission surface and perpendicular to the optical path defined by a direction of emission of electromagnetic radiation from the light emitter, and is supported at only one end. For example, the transducer is a MEMS structure. A deflection of the cantilever results in a bending of the cantilever towards or away from the emission surface, depending on whether the cantilever is heated or cooled, and whether the side facing the emission surface is formed from the material with the respective high or low coefficient of thermal expansion.

In an embodiment, the micro-opto-mechanical transducer is a double-clamped beam. Alternatively to the transducer being a single-sidedly clamped cantilever as described above, the transducer can be a MEMS beam that is clamped to support structures on both ends. A deflection of the beam results in a bending of the center of mass of the beam towards or away from the emission surface, depending on whether the cantilever is heated or cooled, and whether the side facing the emission surface is formed from the material with the respective high or low coefficient of thermal expansion.

In an embodiment, the light emitter is a vertical-cavity surface-emitting laser, VCSEL. VCSEL diodes are characterized by a beam emission that is perpendicular to a main extension plane of a top surface of the VCSEL. The VCSEL diode can be formed from semiconductor layers on a substrate, wherein the semiconductor layers comprise two distributed Bragg reflectors (DBR) enclosing active region layers in between and thus forming a cavity. VCSELs and their principle of operation are a well-known concept and are not further detailed throughout this disclosure. For example, the VCSEL diode is configured to have an emission wavelength of 940 nm, 850 nm, or another natural wavelength. The VCSEL diode can be configured to emit coherent laser light when forward biased, for instance. Suitable alternative light emitters include semiconductor lasers such as edge emitters, quantum cascade and quantum dots laser with suitable optical elements such as lenses, grating couplers etc., for coupling light in and out of such laser devices.

In an embodiment, the detection unit, for detecting the degree of the generated SMI, is configured to measure an electrical property of the light emitter, in particular a junction voltage or a bias current. A quantity other than a wavelength (and an optical power since it is related to the emission frequency) that is affected by self-mixing interference is typically a laser junction voltage. Therein, it is noted that both the output frequency and the junction voltage in consequence show a dependency with the deflection of the transducer. Hence, a measurement of the junction voltage, e.g. the junction voltage of a VCSEL, provides a convenient way to determine the deflection of the transducer as its signature is directly and essentially without delay transferred via the SMI to the junction voltage of the light emitter, e.g. of the VCSEL diode. Alternatively, a modulation of the bias current could be detected as the changing electronic property of the light emitter, for instance.

In an embodiment, the optical sensor element further comprises a photodetector. Therein, the light emitter is further configured to emit the coherent electromagnetic radiation through a further emission surface other than the emission surface, the photodetector is configured to detect the electromagnetic radiation emitted through the further emission surface, and the detection unit, for detecting the degree of the generated SMI, is configured to measure an amount of electromagnetic radiation detected by the photodetector. The photodetector can be engineered such that it is sensitive, e.g. has its peak sensitivity, at a wavelength of the coherent electromagnetic radiation emitted by the light emitter.

Alternatively or in addition to the readout of the electrical property, the optical sensor element can comprise a photodetector for detecting an optical output power of the light emitter. For example, the light emitter is a VCSEL with two-sided emission through a first emission surface and a second emission surface opposite the first emission surface. The transducer is arranged spaced away from the first emission surface, e.g. a top emission surface facing the transducer, of the laser and the photo-sensitive element is arranged at or spaced away from the second emission surface of the laser, e.g. a bottom side of the cavity facing a substrate. Thus, the photodetector can detect the signatures of self-mixing interference due to a modulation of the output optical power through the second emission surface. In other words, the photodetector is arranged on a monitor output of the cavity.

In an embodiment, the optical sensor element further comprises a lens element arranged distant from the transducer opposite the light emitter and being configured to direct the thermal radiation onto a surface of the transducer. For directing the thermal radiation to the transducer such that optimal absorption is achieved, a lens element can focus the thermal radiation onto the transducer in a similar manner as optical lenses direct visible light onto an image sensor or onto pixels of an image sensor, for instance. The lens element can be formed from germanium (Ge), potassium bromide (KBr), zinc selenide (ZnSe), or sodium chloride (NaCl), for example. The lens element is arranged between a source of thermal radiation and a top surface of the transducer facing away from the light emitter.

In an embodiment, the lens element is a metalens. Metalenses can be formed from a transparent material having nanostructures arranged on at least one side that are configured to focus light in a similar manner compared to conventional lenses. Compared to the latter, metalenses are less bulky as they do not require a curved surface, for instance. Like conventional LWIR lenses, the same material choices can be used for realizing a metalens as the lens element. The metalens can comprise a dielectric material or a semiconductor material such as amorphous silicon, germanium or a metal. The metalens may comprise structures like pillars, slots or holes, or H, U, V, + (plus) or cross-shaped structures.

In an embodiment, the optical sensor element further comprises a filter element arranged distant from the transducer opposite the light emitter and being characterized by a passband comprising a long-wavelength infrared, LWIR, portion of the electromagnetic spectrum. For restricting unwanted radiation from reaching the transducer where it is possibly likewise absorbed, the optical sensor element can further comprise a filter element arranged at a side of the transducer, on which the thermal radiation is incident, in order to block, e.g. reject or absorb, any unwanted light. The filter element can be a directional filter element that also blocks light at LWIR wavelengths that impinge on the filter element at an incident angle larger than a maximal acceptance angle.

In an embodiment, the optical sensor element further comprises a further lens element arranged between the transducer and the emission surface and being configured to direct the electromagnetic radiation from the light emitter onto a surface of the transducer, and to reinject the reflected electromagnetic radiation into the cavity of the light emitter. Like directing the thermal radiation onto the transducer, the optical sensor element can likewise comprise a lens element for focusing light from the light emitter onto the transducer, such that its deflection can be optimally detected.

The aforementioned object is further solved by a thermal image sensor that comprises a plurality of pixels and a processing unit configured to generate a thermal image signal from the output signal of each of the pixels. Therein, each of the pixels comprises an optical sensor element according to one of the aforementioned embodiments.

A thermal image sensor comprising a plurality of optical sensor elements allows for thermal imaging, i.e. for measuring the thermal radiation across a sensing surface and reconstructing an image from the outputs of the individual optical sensor elements. Specifically, the processing unit is configured to receive the output signals from the individual pixels and generates an image signal from the output signals in an analogous manner compared to the reconstruction of conventional images. As the optical sensor element acts as a converter between thermal radiation and an interference signal, the generated image signal can be referred to as a thermal image similar to those generated by means of conventional thermal camera systems, however, using a much more compact and integratable image sensor.

In an embodiment, the processing unit (102) is further configured to divide the plurality of pixels (101) into subgroups of pixels, during an idle phase of the image sensor, enable a sensor operation of a monitoring pixel of at least one subgroup of pixels while the remaining pixels are disabled, and upon detection of a signal above a threshold by means of the monitoring pixel, enable an active phase of the image sensor, wherein a sensor operation of all pixels of each subgroup of pixels is enabled.

For example, a field of view of the thermal image sensor can be divided into regions and mapped onto the sensor. In other words, a two-dimensional sensor array [M×N] can be divided into [m,n] regions. In each of these regions all pixels are disabled except for one or two so-called monitoring pixels. This way, the bulk of pixels are disabled except for the few monitoring pixels, which map to key regions in the field of view. When a certain signal is detected by any or all of the monitoring pixels within a region, the operation of all pixels in said region or the entire pixel array can be enabled.

Thus, the resolution of the thermal image sensor can be dynamically adjusted by switching on or off certain optical sensor elements in the array forming the image sensor. When the light emitter does not emit light, there is no self-mixing signal. This allows for the image sensor to be used in situations where a camera device is activated when motion is detected so as to save power. This can allow for specific applications such as occupancy monitoring with low power. For example, there may be situations in occupancy monitoring and counting when the imaging camera needs to be switched on only when a presence of people is detected inside a room that is monitored. Upon detection of this presence using only a few pixels of the image sensor, the camera resolution can be increased to full capacity, i.e. all pixels are enabled, in order to enable the counting process. This feature thus enables low power operation which can be beneficial for IOT and mobile applications. Another application can be for thermal imaging for static versus streaming operation to save bandwidth and power while operation.

Alternatively or in addition, the thermal image sensor can have a low power or idle mode, where only a small number of randomly chosen pixels, groups of pixels, or groups of pixels in regions of interest is turned on or is active during operation of the thermal image sensor, while the remaining pixels are off or inactive. For example, in the low power or idle mode the number of active pixels is at most one tenth or one hundredth of the total number of pixels. In particular, a pixel is active or turned on, if the light emitter of the corresponding pixel emits electromagnetic radiation.

Moreover the thermal image sensor can have an imaging mode, where all pixels or a majority of pixels are active. For example, the thermal image sensor is woken up and operated in the imaging mode, if an event or change in the output signal of one or more active pixels is detected during operation in the low power or idle mode.

In an embodiment, the plurality of pixels forms a one-dimensional array. For example, the thermal image sensor can be a 1D line scanner configured to capture thermal signals along one dimension. Alternatively, the plurality of pixels forms a two-dimensional array for enabling two-dimensional imaging similar to that of conventional image sensors employed in modern image capturing devices.

In an embodiment, the thermal image sensor further comprises a lens arrangement arranged distant from the transducers of the pixels opposite the light emitters and being configured to direct the thermal radiation onto a surface of the transducers.

In an embodiment, the lens arrangement is a micro-lens array. In a micro-lens array, each of the pixels can have its own lens element as described above, thus effectively forming a micro-lens array as the pixels typically feature footprints in the order of tens or hundreds of micrometer squared. The micro-lens array can be realized as a metalens array.

In an embodiment, the lens arrangement comprises a metalens. As mentioned above, less sensor height can be achieved by means of metalenses compared to conventional lenses. Therein, the thermal image sensor can comprise a single metalens covering the pixels of the image sensor, or each pixel comprises a dedicated metalens element as described above.

Furthermore, an electronic device is provided, the electronic device comprising an optical sensor element or a thermal image sensor according to one of the embodiments described above. The electronic device can be a mobile or portable device including a smartphone, a tablet computer, a laptop computer or a wearable accessory such as a smart wristband, a smartwatch or an earphone device.

Furthermore, a method of detecting thermal radiation is provided. The method comprises emitting, by means of a light emitter, coherent electromagnetic radiation through an emission surface of the light emitter towards a micro-opto-mechanical transducer arranged distant from the emission surface. The method further comprises reinjecting, by means of reflection off the transducer, the electromagnetic radiation into a cavity of the light emitter, and inducing self-mixing interference, SMI, within the cavity caused by the reinjected electromagnetic radiation. The method further comprises detecting a degree of the SMI, and determining from the detected degree a mechanical deflection of the transducer. Therein, the transducer is configured to undergo the mechanical deflection according to thermal radiation absorbed by the transducer.

Further embodiments of the method become apparent to the skilled reader from the aforementioned embodiments of the optical sensor element, the thermal image sensor, and the electronic device, and vice-versa.

### BRIEF DESCRIPTION OF THE DRAWINGS

The following description of figures may further illustrate and explain aspects of the optical sensor element, the thermal image sensor and the method of detecting thermal radiation. Components and parts of the optical sensor element that are functionally identical or have an identical effect are denoted by identical reference symbols. Identical or effectively identical components and parts might be described only with respect to the figures where they occur first. Their description is not necessarily repeated in successive figures.

In the figures:

FIG. 1 shows a first exemplary embodiment of an optical sensor element according to the improved concept;

FIG. 2 shows a second exemplary embodiment of an optical sensor element;

FIG. 3 shows an exemplary embodiment of a thermal image sensor comprising a plurality of optical sensor elements;

FIG. 4 shows an exemplary array of opto-mechanical transducers employed in a thermal image sensor;

FIG. 5 shows various exemplary embodiments of opto-mechanical transducers employed in an optical sensor element; and

FIG. 6 shows a schematic of an electronic device comprising a thermal image sensor.

### DETAILED DESCRIPTION

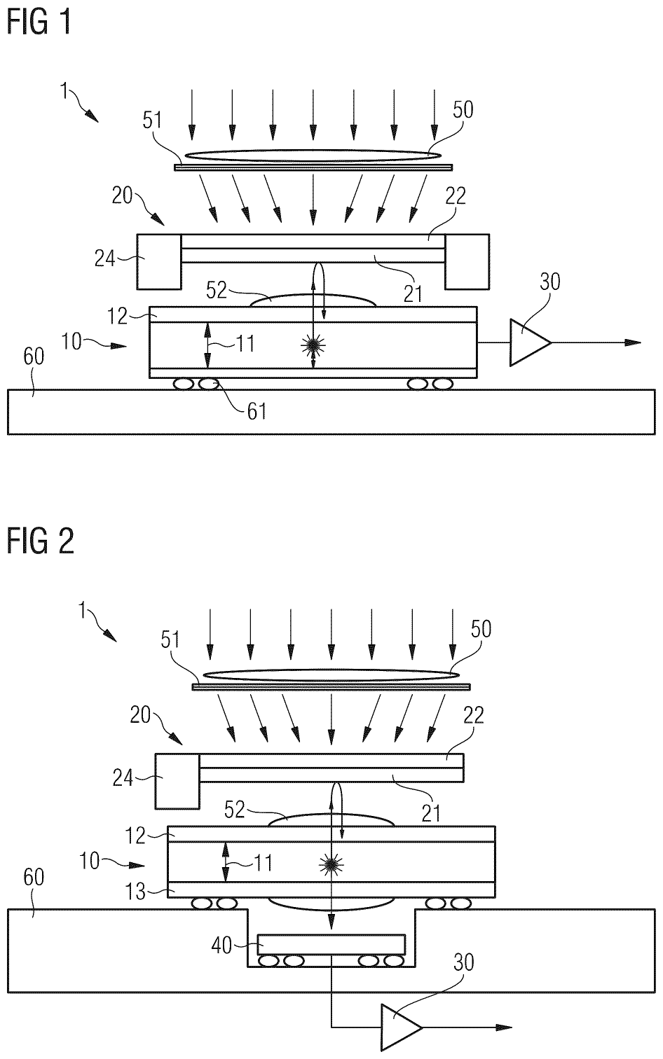

FIG. 1 shows a first exemplary embodiment of an optical sensor element 1 according to the improved concept. The optical sensor element 1 comprises a light emitter 10 that is arranged on an integrated circuit substrate 60, e.g. a silicon chip comprising an integrated circuit, and electrically connected to circuitry of the substrate 60. The electrical connection between the light emitter 10 and contacts of the integrated circuit substrate 60 is realized via connection elements 61, e.g., solder bumps formed from an electrically conductive material such as AgSN, Cu or Au, for instance.

The light emitter 10 can be a vertical cavity surface emitting laser, VCSEL, and comprises an emission surface 12, e.g. formed by a partially transmissive Bragg mirror with respect to an emission wavelength of the VCSEL. The light emitter 10 further comprises a cavity 11 arranged in between the emission surface 12 and a surface of the laser opposite the emission surface 12, wherein the cavity 11 acts as an optical resonator. The light emitter 10 is configured to emit coherent light in a vertical direction through the emission surface 12 as indicated in the figure. The light emitter 10 can be configured to emit light in the infrared, IR, visible or ultraviolet, UV, domain of the electromagnetic spectrum. For example, the light emitter 10 is based on GaAs/AlGaAs materials and emits light in the NIR range of 750-980 nm, in particular around 850 nm. Other longer wavelength of e.g. 1.3 μm, 1.55 μm or beyond 2 μm can be obtained using a VCSEL with alternative materials, such as indium phosphide, for instance. For readout using a photodetector, its sensitivity at the respective wavelength of operation can be ensured by choosing appropriate materials for ensuring a corresponding sensitivity.

The optical sensor element 1 further comprises a micro opto-mechanical transducer 20, e.g. in this case a double-sided clamped beam, which is spaced away from the emission surface 12 of the light emitter 10. In other words, the transducer 20 is suspended above the emission surface 12 with a gap formed between the transducer 20 and the light emitter 10. For example, the transducer 20 is clamped to support structures 24 of a MEMS die that is bonded to the integrated circuit substrate 60 via spacers. The transducer 20 is formed from a bimetal-type structure comprising a first layer 21 and a second layer 22 arranged on a top surface of the first layer 21. The first and second layers 21, 22 are formed from different materials, wherein the materials differ at least in terms of their coefficient of thermal expansion. For example, the first layer 21 is formed from a material of the support structure 24, e.g. silicon, while the second layer 22 is formed from a metal such as gold. Typical gap heights are in the tens or hundreds of micrometers and depend on space constraints on the intended application.

This leads to the fact that a deflection in the direction of the emission occurs upon absorption of thermal photons, i.e. photons in the LWIR range within the transducer 20 as the first and second layers 21, 22 experience a different expansion owing to their different coefficients of thermal expansion. Thus, a principle direction of deflection of the transducer 20 is parallel to an emission direction of the light emitter 10, such that a deflection of the transducer 20 changes a gap distance between the transducer 20 and the emission surface 12 of the light emitter 10. Depending on whether the coefficient of thermal expansion of the second layer 22 is larger or smaller than that of the first layer 21, the transducer 20 either deflects towards or away from the light emitter 10 upon heating due to thermal absorption, in turn either decreasing or increasing the gap between the transducer 20 and the light emitter 10.

The transducer 20 is at least locally reflective on the surface of the transducer 20 that faces the light emitter 10, meaning that light from the light emitter 10 that impinges on the transducer 20 is reflected back towards the light emitter 10. The reflecting property of the surface can be realized by rendering a surface of the transducer 20 itself reflective, or a mirror layer is arranged on the bottom side of the transducer 20 facing the light emitter 10. The reflecting surface ensures that light from the light emitter 10, which impinges on the reflecting surface, is directed back towards the emission surface 12 for reinjection of the reflected light into the cavity 11.

As the emitted light from the light emitter 10 is coherent, the reflected light that is reinjected into the cavity 11 through the emission surface 12 is superimposed with the light inside the cavity 11 depending on the phase shift introduced by the round trip travel to and from the transducer 20. This in turn leads to changes in the properties of the light emitted from the light emitter 10 including the output frequency, the line width, the threshold gain and consequently the output power. Thus, the occurring self-mixing interference results in an alteration of the frequency (and optionally of the amplitude) of the laser oscillating field inside the cavity 11. A deflection of the transducer 20 along the emission direction of the light emitter 10 causes a distance between the transducer 20 and the light emitter 10 to change. Therein even smallest deflections suffice for the detectable alteration of SMI inside the cavity 11.

The optical sensor element 1 further comprises a detection unit 30 that is electrically coupled to the light emitter 10 such that an electrical property of the light emitter 10 can be detected by means of the detection unit 30. For example, the detection unit 30 comprises means to monitor and detect a junction voltage of the light emitter 10, e.g. a VCSEL junction voltage. Alongside the optical power of the light emitter 10, the junction voltage is likewise affected by self-mixing and also shows a change upon deflection of the transducer 20. It is noted, however, that while the output power varies proportionally with the change in deflection, the junction voltage exhibits an inverse relationship. In other words, an increase in laser power coincides with a decrease in laser junction voltage. Alternatively, the electronic control unit 20 can comprise means to monitor and detect changes in a bias current of the light emitter 10, showing a similar change due to a deflection of the transducer 20.

The detection unit 30 further comprises means to analyze the electrical property and determine from a detected change in the electrical property the deflection of the transducer 20 and to generate an output signal that comprises information of the deflection. This deflection can consequently be directly converted into an amount of thermal radiation absorbed by the transducer 20 in response to incident thermal radiation.

The optical sensor element 1 in this embodiment further comprises a lens element 50 for directing incident thermal radiation onto a surface of the transducer 20. For example, the lens element 50 is formed from germanium (Ge), potassium bromide (KBr), zinc selenide (ZnSe), or sodium chloride (NaCl), for example, and is transmissive for photons in the LWIR range at least. The lens element 50 is arranged between a source of thermal radiation and a top surface of the transducer 20 facing away from the light emitter 10. For example, the lens element 50 is configured to focus incoming parallel beams of light onto a point or surface of the transducer 20 that experiences a maximum deflection upon heating. An additional lens element 52 can be employed for collimating the light emitted by the light emitter 10, and for focusing the reflected light back into the cavity 11. This further lens element 52 is arranged between the light emitter 10 and the transducer 20, e.g. it is arranged on the emission surface 12.

The optical sensor element 1 in this embodiment further comprises an optical filter element 51 that is characterized by a passband in the LWIR range. In other words, the filter element 52, similar to an optical filter in the visible domain, is configured to transmit light in the LWIR range while light outside this range is rejected. For example, unwanted light is absorbed or reflected. In addition, a transmission behavior of the filter element 51 can be angle dependent, such that only LWIR light impinging on the filter within a predetermined angle of incidence range is transmitted, while stray light form the side, for example, is rejected.

FIG. 2 shows a second exemplary embodiment of an optical sensor element 1 according to the improved concept. Compared to the embodiment of FIG. 1, in this embodiment the transducer 20 is a cantilever, i.e. a single-sided clamped strip. Similar to the double-clamped beam of FIG. 1, the cantilever is a bimetal structure that due to this experiences a deflection when heated or cooled from an initial temperature. The deflection again alters a gap between the transducer 20 and the light emitter 10 such that a self-mixing interference signal inside the cavity 11 is altered.

A further difference to the first embodiment is the readout mechanism, which in this case is optical instead of electrical. To this end, the optical sensor element 1 further comprises a photodetector 40, e.g. realized as a silicon-based photodiode, as VCSELs typically emit in the visible or NIR range, at which silicon is photosensitive, arranged on or within a surface of the substrate 60. Moreover, the light emitter 10 in this embodiment is configured to perform two-sided emission. In other words, both ends of the cavity are defined by partially transmissive Bragg mirrors such that the light is emitted through the emission surface 12 towards the transducer 20, and through a further emission surface 13 towards the photodetector 40. As mentioned before a changing distance between transducer 20 and light emitter 10 changes the self-mixing interference inside the cavity, which in turn alters an output optical power of the light emitter, in this case through both the emission surface 12 and the further emission surface 13. Thus, an amount of light captured by the photodetector 40 within a specified integration time directly carries information about a degree of self-mixing interference, and hence of a deflection position of the transducer 20.

Thus, the detection unit 30, in this embodiment is coupled to the photodetector 40 and is configured to determine from a photo signal, e.g. a photo current, generated by the photodetector 40, a degree of the SMI and thus a deflection of the transducer 20, from which an amount of absorbed thermal radiation can be determined. Like the further lens element 52 arranged on the emission surface 12, the optical sensor element 1 can comprise a further lens element 52 also in between the further emission surface 13 and the photodetector 40 for directing, e.g. focusing, light from the light emitter 10 onto the photodetector 40.

Without loss of generality, the features of the first and second embodiments, i.e. the transducer type and the detection mechanism can be interchanged as the deflection of all types of bimetallic transducers 20 manifests itself in a corresponding degree of self-mixing interference, which can be read out either electrically or optically.

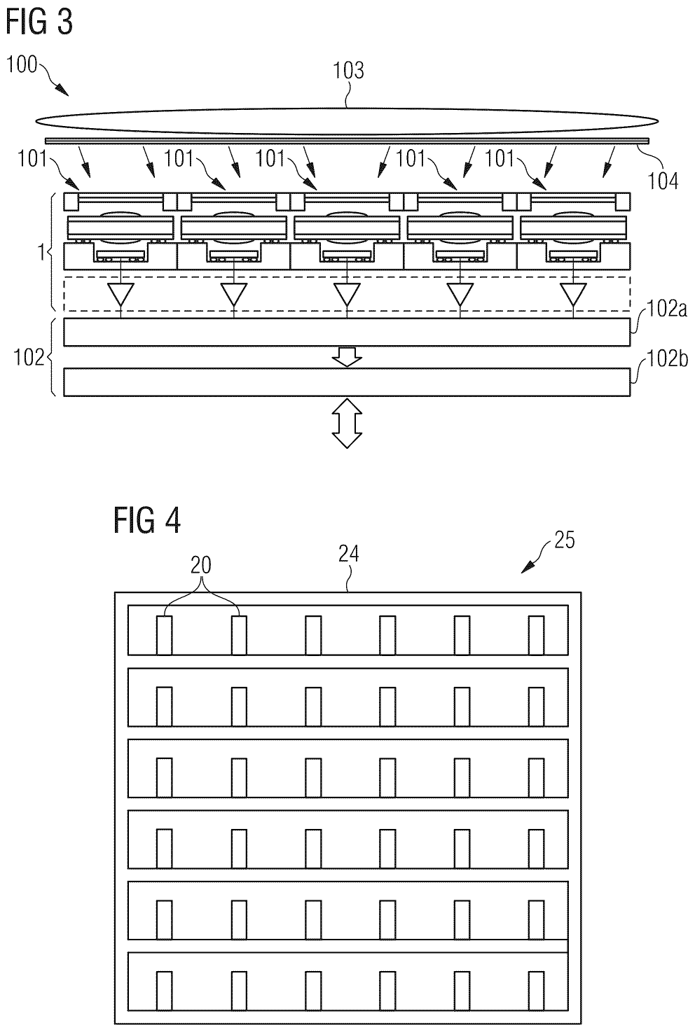

FIG. 3 shows an exemplary embodiment of a thermal image sensor 100 according to the improved concept. The image sensor 100 comprises an array, one or two-dimensional depending in the application, of a plurality of pixels 101, wherein each of the pixels 101 comprises an optical sensor element 1. In contrast to the first and second exemplary embodiments of the optical sensor element 1 of FIGS. 1 and 2, in this embodiment the lens arrangement 103 is illustrated as a single LWIR lens that directs incoming thermal radiation onto the pixels 101 of the image sensor 100. However, each pixel 101 can comprise its own lens element, e.g. forming a micro lens array as the lens arrangement 103, for achieving the same purpose and without limiting the functionality of the improved concept. Instead of optical lenses, the lens arrangement 103 can be likewise formed from one or more metalenses, e.g. forming a micro metalens array. Likewise, the filter element 104 can be a single filter element spanning across the image sensor 100, or each pixel 101 has its own filter element as described above.

The thermal image sensor 100 further comprises a processing unit 102, in this case formed from an analog portion 102a for receiving the output signals from the optical sensor element 1 from each pixel 101 and for performing analog-to-digital conversion, for instance. A second element of the processing unit 102 is a digital portion 102b, comprising digital logic and interface circuits, for example, for reconstructing the thermal image that is output as a thermal image signal by the processing unit 102. The processing unit 102 can further comprise circuitry for setting an integration time, switch between readout modes and other applications common to the operation of image sensors.

FIG. 4 shows an exemplary array 25 of micro opto-mechanical transducers 20 employed in a thermal image sensor 100, e.g. in that of FIG. 3. The array 25 comprises a support structure 24, e.g. a supporting frame formed from silicon, for supporting the individual micro opto-mechanical transducers 20, wherein as described throughout this disclosure, each transducer 20 is part of an optical sensor element 1. Thus, the depicted array 25 is part of a thermal image sensor having a two-dimensional array of pixels 101. Alternatively, an optical sensor element 1 can comprise a one-dimensional array of pixels 101 for realizing a 1D line-scan sensor array, for instance.

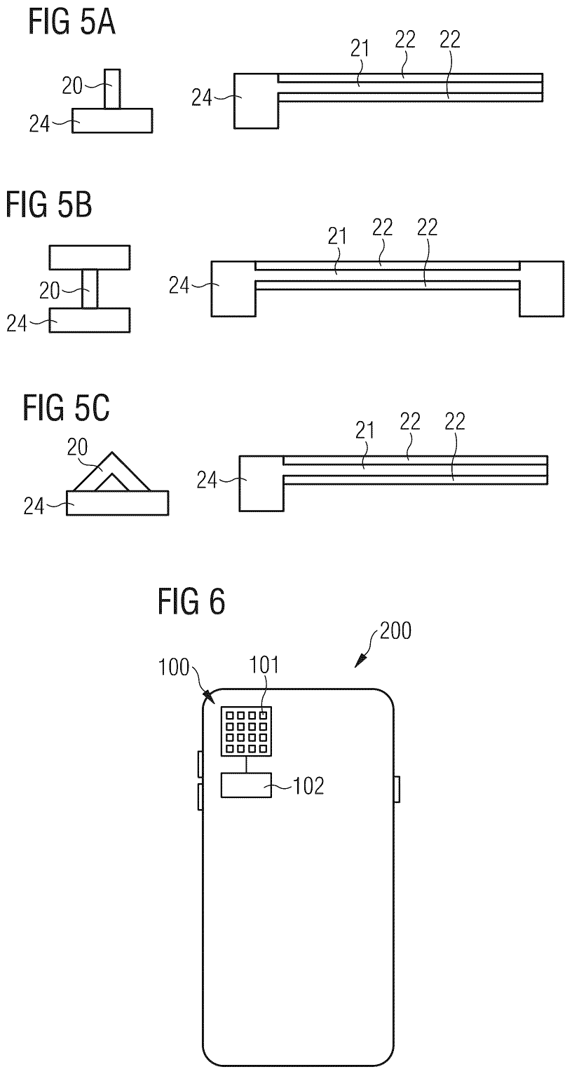

FIG. 5 shows various exemplary embodiments of opto-mechanical transducers 20 employed in an optical sensor element 1 according to the improved concept. FIG. 5a illustrates a top view and cross-sectional schematic of a bimorph or bimetallic-type cantilever formed from three layers, wherein the first layer 21 is formed as a strip of silicon extending away from the support structure 24, likewise made of silicon, wherein the strip is coated on its top and bottom side with second layers 22, e.g. formed from gold. Gold is a suitable material as it possesses a significantly different coefficient of thermal expansion compared to silicon and can be deposited in a straightforward manner using existing fabrication techniques. Alternatively, only a top or a bottom side of the silicon strip, i.e. the first layer 21, can be coated with a second layer 22.

FIG. 5b illustrates a top view and cross-sectional schematic of a bimetallic-type double-sided clamped beam, likewise forming a bimorph structure by arranging second metallic layers 22 on a bottom and/or a top surface of the beam formed from the first layer 21, e.g. silicon. Finally, FIG. 5c illustrates a top view and cross-sectional schematic of a bimetallic triangular cantilever, wherein two ends of the triangular structure are clamped to the same support structure. Like the ordinary cantilever and the double clamped beam, the triangular cantilever likewise can be coated on both sides with a metal for forming a bimetallic structure. These shapes illustrate different exemplary shapes of the transducer 20 employed in an optical sensor element 1 according to the improved concept and can differ in terms of their response, i.e. deflection, with respect to absorbed thermal radiation and can be engineered according to the requirements of the actual application.

FIG. 6 shows a schematic of an electronic device 200 comprising a thermal image sensor 100, e.g. according to the embodiment of FIG. 3. For example, the electronic device 200 is a smart phone, as depicted. Alternatively, the electronic device can be any portable or mobile electronic device including tablet or laptop computers, augmented or virtual reality glasses, smartwatches or other wearable devices or dedicated thermal camera devices. The thermal image sensor 100 can allow for thermal imaging and hence enable applications such as generating heat maps of buildings and environments or measuring surface temperatures with a resolution. Alternatively, a single optical sensor element 1 can be employed as a thermal detector for measuring temperatures. Alternatively, one or more optical sensor elements 1 can be incorporated into a conventional image sensor as additional thermal pixels for extending the sensitivity range into the LWIR domain.

The embodiments of the optical sensor element 1, the image sensor 100 and the method of detecting thermal radiation disclosed herein have been discussed for the purpose of familiarizing the reader with novel aspects of the idea. Although preferred embodiments have been shown and described, changes, modifications, equivalents and substitutions of the disclosed concepts may be made by one having skill in the art without unnecessarily departing from the scope of the claims.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

1. An optical sensor element for sensing thermal radiation, comprising:
a light emitter having a cavity, the light emitter being configured to emit coherent electromagnetic radiation through an emission surface and to undergo self-mixing interference, SMI, caused by reflected electromagnetic radiation reinjected into the cavity;
a micro-opto-mechanical transducer arranged distant from the emission surface, the transducer being configured to undergo mechanical deflection according to thermal radiation absorbed by the transducer, and to reflect the electromagnetic radiation emitted by the light emitter back into the cavity for generating the SMI; and
a detection unit configured to:
detect a degree of the generated SMI;
determine from the detected degree a deflection of the transducer; and
generate an output signal indicating the determined deflection.

2. The optical sensor element according to claim 1, wherein the micro-opto-mechanical transducer comprises a bimorph or bimetallic-type layer structure formed from a first layer of a first material and a second layer of a second material, the first and second materials having different coefficients of thermal expansion.

3. The optical sensor element according to claim 2, wherein the first layer comprises silicon and the second layer comprises a metal.

4. The optical sensor element according to claim 2, wherein the first layer forms a strip and the second layer is arranged on a top and a bottom side of the strip.

5. The optical sensor element according to claim 1, wherein the micro-opto-mechanical transducer is a cantilever or a double-clamped beam.

6. The optical sensor element according to claim 1, wherein the light emitter is a vertical-cavity surface-emitting laser, VCSEL.

7. The optical sensor element according to claim 1, wherein the detection unit, for detecting the degree of the generated SMI, is configured to measure an electrical property of the light emitter, in particular a junction voltage or a bias current.

8. The optical sensor element according to claim 1, further comprising a photodetector; wherein
the light emitter is further configured to emit the coherent electromagnetic radiation through a further emission surface other than the emission surface;
the photodetector is configured to detect the electromagnetic radiation emitted through the further emission surface; and
the detection unit, for detecting the degree of the generated SMI, is configured to measure an amount of electromagnetic radiation detected by the photodetector.

9. The optical sensor element according to claim 1, further comprising a lens element arranged distant from the transducer opposite the light emitter and being configured to direct the thermal radiation onto a surface of the transducer.

10. The optical sensor element according to claim 9, wherein the lens element is a metalens.

11. The optical sensor element according to claim 1, further comprising a filter element arranged distant from the transducer opposite the light emitter and being characterized by a passband comprising a long-wavelength infrared, LWIR, portion of the electromagnetic spectrum.

12. The optical sensor element according to claim 1, further comprising a further lens element arranged between the transducer and the emission surface and being configured to direct the electromagnetic radiation from the light emitter onto a surface of the transducer and to reinject the reflected electromagnetic radiation into the cavity of the light emitter.

13. A thermal image sensor comprising:
a plurality of pixels, with each pixel comprising an optical sensor element according to claim 1; and
a processing unit configured to generate a thermal image signal from the output signal of each of the pixels.

14. The thermal image sensor according to claim 13, wherein the plurality of pixels forms a one-dimensional array or a two-dimensional array.

15. The thermal image sensor according to claim 13, further comprising a lens arrangement arranged distant from the transducers of the pixels opposite the light emitters and being configured to direct the thermal radiation onto a surface of the transducers.

16. The thermal image sensor according to claim 15, wherein the lens arrangement is a micro-lens array.

17. The thermal image sensor according to claim 15, wherein the lens arrangement comprises a metalens.

18. The thermal image sensor according to claim 13, wherein the processing unit is further configured to:
divide the plurality of pixels into subgroups of pixels;
during an idle phase of the image sensor, enable a sensor operation of a monitoring pixel of at least one subgroup of pixels while the remaining pixels are disabled; and
upon detection of a signal above a threshold by means of the monitoring pixel, enable an active phase of the image sensor, wherein a sensor operation of all pixels of each subgroup of pixels is enabled.

19. An electronic device comprising an optical sensor element according to claim 1.

20. A method of detecting thermal radiation, the method comprising:
emitting, by means of a light emitter, coherent electromagnetic radiation through an emission surface of the light emitter towards a micro-opto-mechanical transducer arranged distant from the emission surface;
reinjecting, by means of reflection off the transducer, the electromagnetic radiation into a cavity of the light emitter;
inducing self-mixing interference, SMI, within the cavity caused by the reinjected electromagnetic radiation;
detecting a degree of the SMI; and
determining from the detected degree a mechanical deflection of the transducer;
wherein the transducer is configured to undergo the mechanical deflection according to thermal radiation absorbed by the transducer.
